(19) United States
(12) Patent Application Publication
(10) Pub. No.: US 2016/0325822 A1
(43) Pub. Date: Nov. 10, 2016

(54) HORIZONTAL TAIL PLANE WITH A MULTI-RIB TORSION BOX

(71) Applicant: AIRBUS OPERATIONS, S.L., GETAFE (Madrid) (ES)

(72) Inventors: Fernando Pereira Mosqueira, Getafe (Madrid) (ES); Andrea-Ivan Marasco, Getafe (Madrid) (ES)

(21) Appl. No.: 15/147,202

(22) Filed: May 5, 2016

(30) Foreign Application Priority Data
May 5, 2015 (EP) 15382231.7

(51) Int. Cl. B64C 5/02; B64C 3/18

(52) U.S. Cl. CPC B64C 5/02; B64C 3/182; B64C 3/185; B64C 3/187

(57) ABSTRACT

The present disclosure generally refers to an aircraft horizontal tail plane (HTP) having a multi-rib torsion box formed by first and second lateral torsion boxes symmetrically arranged with respect to a plane of symmetry of the horizontal tail plane. A group of ribs are substantially parallel to the plane of symmetry of the horizontal tail plane, and the stringers are arranged as to define an angle within the range 80°-100° with respect to the plane of symmetry of the horizontal tail plane. Due to this relative arrangement of the ribs and stringers, the stringers are not continuous through ribs, thus the ribs can be manufactured without mouse holes. The HTP of the invention can be manufactured easier and faster than traditional HTP designs.

### CROSS-REFERENCE TO RELATED APPLICATIONS

The present disclosure claims priority to European Application No. 15382231.7 filed on May 5, 2015, which is hereby incorporated by reference, as though set forth fully herein.

### FIELD OF DISCLOSURE

The present disclosure generally relates to aircraft primary structures formed with multi-rib torsion boxes, and is manufactured mainly with composite materials, such as Carbon Fiber Reinforced Plastic (CFRP).

More specifically, an object of the present disclosure is to provide an aircraft horizontal tail plane (HTP) having a multi-rib torsion box, which can be assembled and manufactured easier and faster than traditional HTP designs.

### BACKGROUND OF THE DISCLOSURE

A known structure of a horizontal tail plane (HTP) of an aircraft is shown in FIGS. 1A and 1B, and comprises a multi-rib torsion box 1 formed by front and rear spars 2 and 3, and a plurality of ribs 4 transversally arranged and fitted to the front and rear spars as to form together a box-like configuration. As it can be noted in FIGS. 1A and 1B, the ribs are obliquely arranged with respect to the plane of symmetry of the HTP.

The ribs provide torsional rigidity and support local load introductions resulting from actuator fittings, pivot fittings, support bearings etc., which are directly secured to the front and rear ribs.

Other components of the HTP include leading and trailing edges 5 and 6, which are assembled with the torsion box 1. Elevators are control surfaces of the aircraft and are hinged to the torsion box, which is the structural component of the HTP and as such, it has to withstand the loads to which the HTP is subjected.

An HTP torsion box of the continuous type is formed by two lateral torsion boxes (right-hand side and left-hand side torsion box) joined to each other at the central region of the HTP, and are symmetrically arranged with respect to the plane of symmetry of the horizontal tail plane.

The torsion box also includes upper and lower skin panels internally reinforced by stringers extending longitudinally. Two arrangement patterns and configurations are typically used for the stringers distribution. FIG. 1A shows a first known pattern, wherein the stringers 7 are parallel to each other, are continuous through the ribs 4 and are provided with run-outs sections to avoid interference with the ribs.

FIG. 1B shows a second known pattern, wherein the stringers 7 are arranged in a conical configuration converging towards a tip of the respective torsion box. In this second case the stringers are continuous in the entire length of the torsion box, thus no run-outs are needed.

In these two cases and due to the continuity of the stringers, the stringers interfere with the ribs, such as the ribs have to be designed and manufactured to solve the intersection between these two structural elements. For this reason, the ribs have to be manufactured with the so-called “mouse holes” in order to accommodate several stringers extending through the rib.

This known ribs configuration with mouse holes is shown for example in FIG. 9 of the European Patent No. 2,851,283 A1.

However, the manufacture of this type of ribs with mouse holes is a difficult task and requires specific tooling which is also difficult to manufacture. Furthermore, the assembly of the torsion box components is time-consuming since the stringers have to be received precisely and bonded in the respective mouse holes of the ribs.

### SUMMARY OF THE DISCLOSURE

The present disclosure is defined in the attached independent claim and it overcomes the above-mentioned drawbacks of the prior art, by providing a horizontal tail plane (HTP) having a multi-rib torsion box which assembly and manufacturing process are simplified compared with traditional HTP designs.

Therefore, an aspect of the present disclosure may include a horizontal tail plane for an aircraft, conventionally comprising first and second lateral torsion boxes joined to each other at a central region of the HTP, and symmetrically arranged with respect to the plane of symmetry of the horizontal tail plane.

Another aspect of the present disclosure may include where each of said lateral torsion boxes comprises front and rear spars, and a plurality of ribs having ends respectively joined to the front and rear spars. Upper and lower skin covers are fixed to the torsion box, and are provided with a plurality of stringers internally fixed to one of the covers.

According another aspect of the present disclosure, a group of ribs are arranged substantially parallel to the plane of symmetry of the horizontal tail plane. Additionally, the stringers are arranged as to define an angle within the range 80°-100° with respect to the plane of symmetry of the horizontal tail plane. It has been found, that this stringer distribution is optimum to react to torsional moments which appear at the torsion box.

Since the stringers orientation is +/−10° perpendicular to the plane of symmetry, and the ribs are parallel to that plane of symmetry, it results that ribs and stringers are generally orthogonal to each other.

Due to this relative arrangement between ribs and stringers, the stringers no need to be continuous through ribs, thus each stringers extend only between two consecutive ribs. Therefore, the ribs can be manufactured without mouse holes, such as their manufacturing process is simplified.

In this way, the majority of the HTP stringers are dimensioned such as each stringer has a length shorter or equal than the distance between the two consecutive ribs within which that stringer is placed.

Additionally, some ribs of the horizontal tail plane are orthogonal to the longitudinal axis of the respective rear spar, and are placed in correspondence with an attachment fittings secured to the rear spar. Since these attachment fittings are highly loaded areas of the HTP, this orthogonal ribs enhance loads introduction from the fittings.

Some of the main advantages of the invention are:
optimized stringers arrangement to react more efficiently to torsion moments
combination of ribs parallel to plane of symmetry and ribs orthogonal to rear spars
non-continuous stringers through ribs, eliminate mouse holes in ribs,
minimize assembly and manufacturing time compared with prior art HTP concepts.

### BRIEF DESCRIPTION OF THE FIGURES

Preferred embodiments of the invention, are henceforth described with reference to the accompanying drawings, wherein:

FIGS. 1A and 1B are prior art illustrations of top views of one of the two torsion boxes of a horizontal tail plane, and the traditional layout of the continuous stringers. Specifically, FIG. 1A shows a traditional parallel pattern and FIG. 1B shows a traditional conical pattern.

FIGS. 2A-C show schematic representations in top view of a torsion box of a horizontal tail plane according to an aspect of the present disclosure, wherein FIG. 2A shows only the ribs layout, FIG. 2B shows the stringers layout in addition to the ribs, and FIG. 2C is an enlarged detail of the encircled area in FIG. 2B.

FIG. 3 shows a perspective view of a horizontal tail plane according to an aspect of the present disclosure.

FIG. 4 shows a schematic representation in an elevational view of a torsion box according to an aspect of the present disclosure.

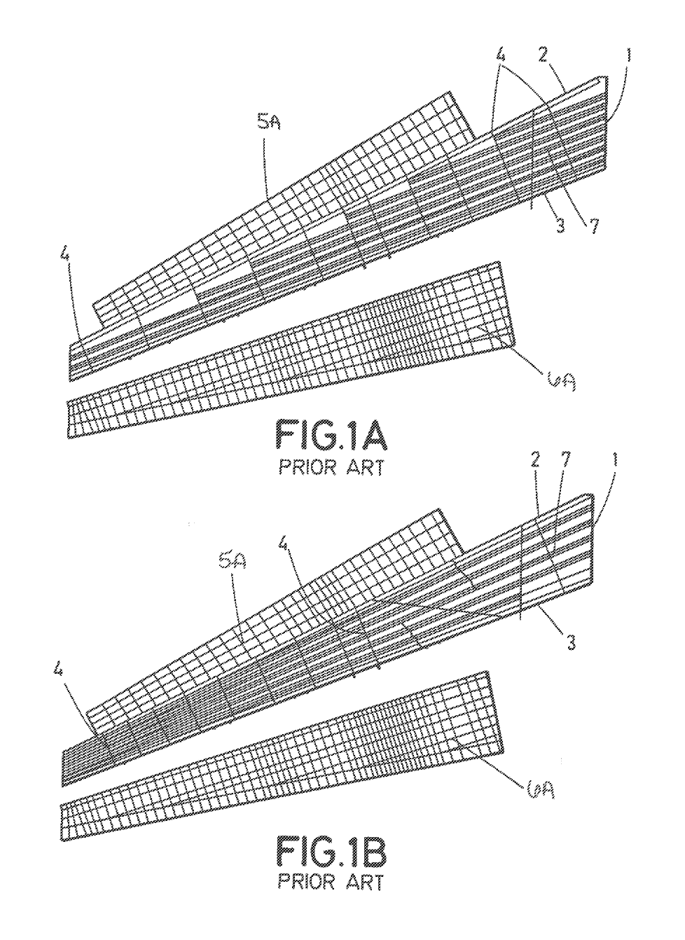

### DETAILED DESCRIPTION OF THE PRESENT DISCLOSURE

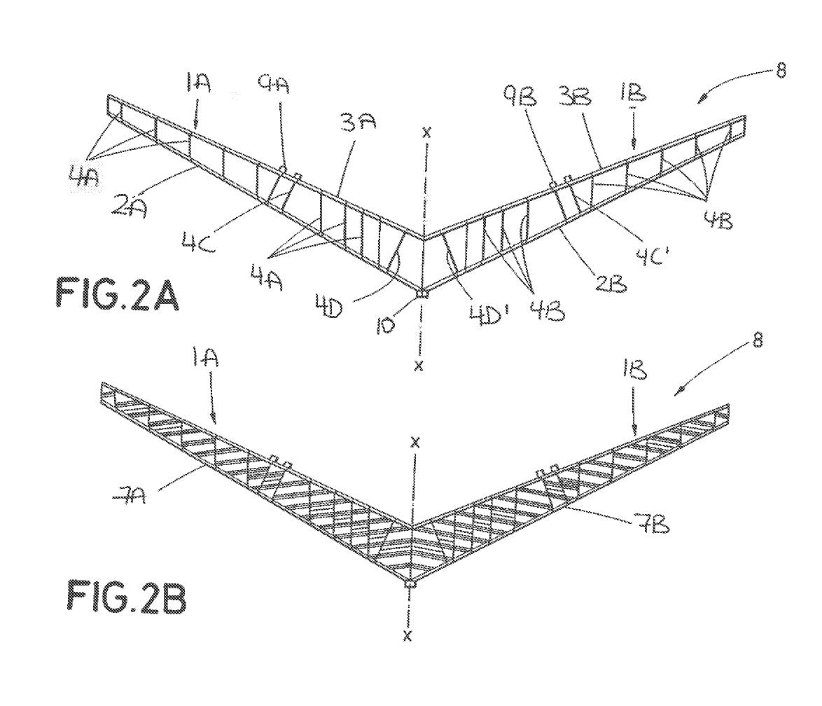

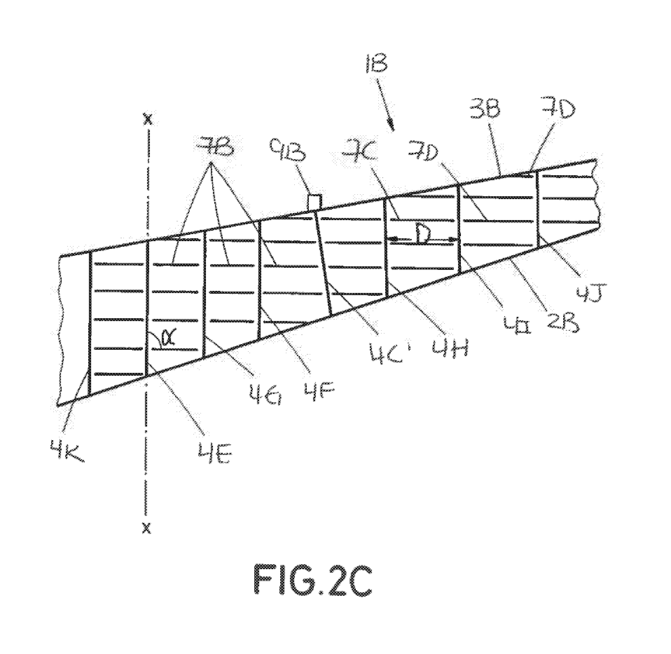

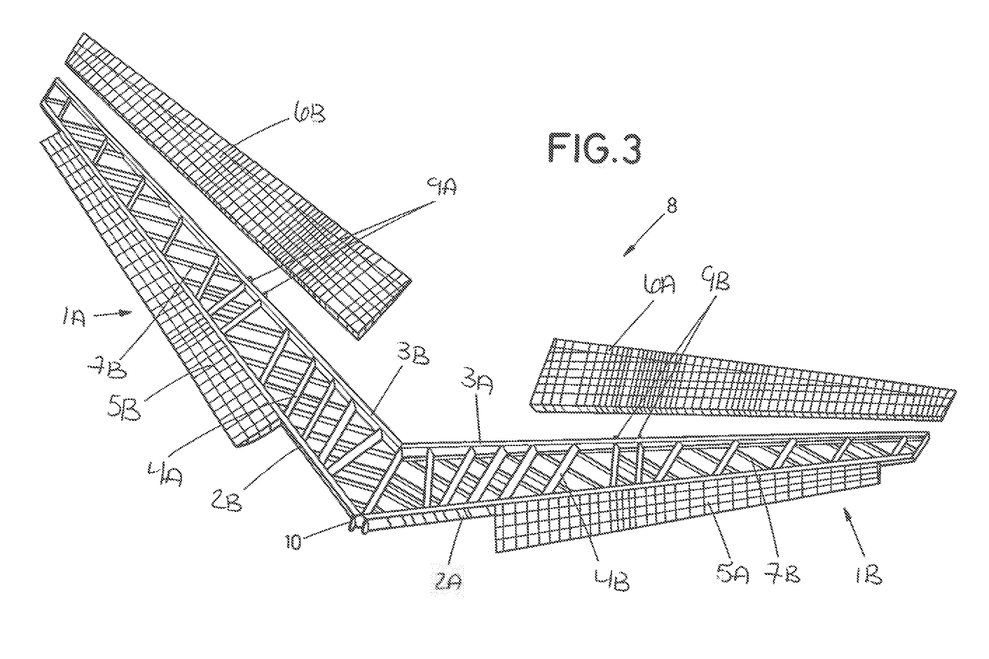

FIG. 2A shows a preferred embodiment of an horizontal tail plane HTP 8 which is a symmetric structure and comprises first and second lateral torsion boxes 1A and 1B, joined to each other at a central region of the HTP, and symmetrically arranged with respect to the axis of symmetry (X) of the HTP. Each of said lateral torsion boxes 1A and 1B is formed by front and rear spars 2A, 3A, 2B, and 3B, and a plurality of ribs 4A-4K and 4C′-4D′ having ends joined to the respective front and rear spars 2A, 3A, 2B, and 3B.

Upper and lower skin covers 11A and 11B are supported by the torsion box, and are stiffened by a plurality of stringers 7A and 7B longitudinally arranged and fixed respectively to internal surfaces of the covers.

According to an aspect of the present disclosure, a group of ribs 4A-4K and 4C′-4D′ (preferably, the majority of the ribs of the HTP), are parallel to the plane of symmetry X of the horizontal tail plane, as shown more clearly in FIG. 2A. Furthermore, the stringers 7A and 7B are arranged as to define an angle a within the range 80°-100° (in top view) with respect to the plane of symmetry X of the horizontal tail plane 8.

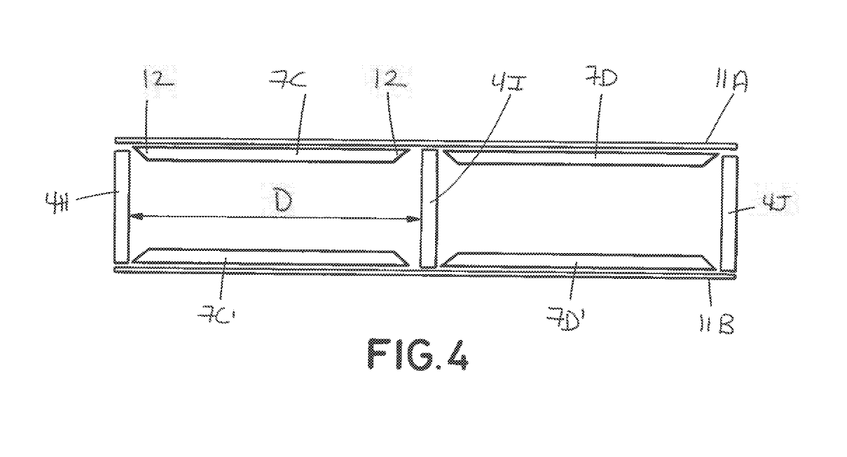

Unlike traditional designs, according to the present disclosure the stringers 7A-7D and 7C′-7D′ are not continuous through ribs 4A-4K and 4C′-4D′, but the stringers 7A-7D and 7C′-7D′ are terminated between consecutive ribs. As shown more clearly in FIG. 4, each stringer is conventionally terminated with run-outs sections 12.

In other words, each stringer is placed between two consecutive ribs, and wherein each stringer is shorter or equal than the distance D between the two consecutive ribs within which that stringer is placed. For example, in the enlarged views of FIGS. 2C and 4, the stringer 7C is placed or is terminated between consecutive ribs 4H and 41, and therefore the stringer 7C is shorter than said distance D. The same configuration is repeated for most of the other stringers of the HTP.

In some cases, for example in the case of stringer 7D, the stringer is much shorter than said distance D and one of its ends is near the rear spar 3B.

Conventionally, in this horizontal tail planes of the continuous type, some attachment fittings 9A and 9B are secured to the rear spars for the attachment of actuator fittings, pivot fittings, support bearings etc. At the front part of the HTP, a front fitting 10 is provided to receive a trimming actuator (not shown) for the HTP.

The horizontal tail plane further includes one or more ribs placed in correspondence with the position of these attachment fittings 9A and 9B at the rear spar, and these ribs are orthogonal to the longitudinal axis of the respective rear spar. This is the case of rib 4C′ in FIG. 2C, which has an end fixed at a position of the rear spar 3B wherein the attachment fitting 9B is located.

In the case of the inner-most ribs 4D and 4D′, that is, the ribs closer to the plane of symmetry X, these ribs can be parallel to the plane of symmetry or orthogonal the rear spars.

As it can be noted in FIGS. 2B and 2C, the stringers 7A-7D and 7C′-7D′ are grouped in rows of aligned stringers, and the rows are parallel to each other.

Most of the components of the HTP are manufactured with composite materials, preferably Carbon Fiber Reinforced Plastic (CFRP) materials, by any know manufacturing process or combination thereof associated to these materials.

The optimized HTP structure of the invention, significantly simplifies the manufacturing and assembly process, since the ribs are now easier to manufacture to the absence of mouse holes (as well as the associated tooling), and there is no interference between ribs and stringers.

What is claimed:

1. A horizontal tail plane for an aircraft, the horizontal tail plane comprising:
a first lateral torsion box and a second lateral torsion box joined to each other at a central region thereof and symmetrically arranged with respect to a plane of symmetry of the horizontal tail plane, wherein each of said lateral torsion boxes comprises front and rear spars, and a plurality of ribs having ends respectively joined to the front and rear spars, and
an upper cover and a lower cover, each upper cover and lower cover having a plurality of stringers internally fixed thereto,
wherein the plurality of ribs are substantially parallel to the plane of symmetry of the horizontal tail plane, wherein said the stringers are arranged as to define an angle within the range of 80°-100° with respect to the plane of symmetry of the horizontal tail plane, wherein the stringers are placed between two consecutive ribs, and wherein each stringer is shorter than the distance between the two consecutive ribs within which that stringer is placed.

2. The horizontal tail plane according to claim 1, wherein the stringers are grouped in rows of aligned stringers, and the rows are parallel to each other.

3. The horizontal tail plane according to claim 2, wherein the group of stringers extends between a rib and one of the rear spar and the front spar.

4. The horizontal tail plane according to claim 1, wherein the rear spars have attachment fittings, and wherein the plurality of ribs are orthogonally arranged with respect to the longitudinal axis of the respective rear spar and placed in correspondence with an attachment fitting.

5. The horizontal tail plane according to claim 1, wherein at least one of the first lateral torsion box, the second lateral torsion box, the upper cover, the lower cover, the plurality of ribs, plurality of stringers, the front spar, and the rear spar are made from a composite material.
